(19) United States
(12) Patent Application Publication
(10) Pub. No.: US 2004/0065757 A1
(43) Pub. Date: Apr. 8, 2004

(54) Nozzle equipped with a bar for introducing molten metal into an ingot mould for continuous metal casting

(76) Inventors: Jean-Michel Damasse, Rome (IT); Laurent Gacher, Sarreguemines (FR)

Correspondence Address: SUGHRUE MION, PLLC, 2100 PENNSYLVANIA AVENUE, N.W., SUITE 800, WASHINGTON, DC, 20037, US

(21) Appl. No.: 10/451,059

(22) PCT Filed: Dec. 17, 2001
(86) PCT No.: PCT/FR01/04022

(30) Foreign Application Priority Data
Dec. 22, 2000 (FR) 00/16975

(51) Int. Cl. B05B 1/14

(52) U.S. Cl. 239/548; 239/556; 239/589

(57) ABSTRACT

The invention concerns a nozzle (1) for introducing molten metal into an ingot mould for continuous metal casting, comprising a first tubular part (2) whereof one end is designed to be connected to a vessel containing said molten metal, and the other end emerges into a second hollow part (4) of elongate shape of which at least one portion of the internal space (3) is oriented substantially perpendicular to the first tubular part (2), said hollow part (4) comprising an orifice (5, 6) at each of its ends, a bar (19, 27,29) provided with perforations (21) being arranged in the internal space (3) of said hollow part (4). The invention is characterised in that the orifices (5, 6) of said hollow part (4) are closed above said bar (19, 27, 29).

The invention relates to the continuous casting of metals. It relates more precisely to the nozzles made from refractory material through which the liquid metal to be cast, such as steel, is introduced into the ingot mould of a continuous casting plant, particularly for twin-roll casting.

These nozzles are connected by their upper end to the vessel serving as reservoir of liquid metal, called a tundish, and their lower end dips into the pool of liquid metal present in the ingot mould where the solidification of the cast product is to be initiated. The principal role of these nozzles is to protect the jet of liquid metal from atmospheric oxidation as it travels between the vessel and the ingot mould. By virtue of appropriate configurations of their lower end, they also allow the flows of liquid metal into the ingot mould to be favourably oriented so that solidification of the product takes place under the best possible conditions.

The casting of thin metal strips a few mm in thickness directly from liquid metal (for example steel or copper) can be carried out on a so-called “twin-roll casting” plant. It comprises an ingot mould, the casting space of which is bounded on its long sides by a pair of rolls which are cooled internally, have parallel horizontal axes and rotate about these axes in opposite directions, and on its short sides by closure plates (called lateral faces) made from refractory material which are applied against the ends of the rolls. The rolls may also be replaced by cooled endless belts.

In twin-roll casting, nozzles in two parts are often used (see, for example, document EP-A-0 771 600). The first part is composed of a cylindrical tube, the upper end of which is connected to an orifice made in the bottom of the tundish which constitutes the reservoir of liquid steel feeding the mould. This orifice can be closed off partially or completely by the operator as required, using a stopper rod or a sliding nozzle system which ensures the regulation of the flow rate of the metal. The maximum flow rate of metal which can flow into the nozzle depends upon the cross-section of this orifice. The second part, fixed to the lower end of the preceding tube, for example by screwing or by being produced integrally with it during construction, is intended to be immersed in the pool of liquid metal present in the ingot mould. It is composed of a hollow element inside which the lower orifice of the preceding cylindrical tube opens. The internal space of this hollow element has a more or less elongate general shape depending on the dimensions of the casting space of the machine on which the nozzle is to be mounted. It is oriented approximately perpendicular to the tube. When the nozzle is in service the hollow element is placed parallel to the rolls and the liquid metal flows into the ingot mould via outlets made on the sides of the hollow element, generally at each of its ends. Thus in this latter case, the flows of metal leaving the nozzle are preferably oriented in the direction of the lateral faces in order to bring hot metal onto their surfaces and thus to prevent undesirable solidification of metal (so-called “parasitic solidification”) from occurring thereon, which would seriously disrupt the operation of the machine. The outlets may have a horizontal or downward oblique orientation. Various orifices smaller than these outlets may also be provided on the lateral walls and/or the base of the nozzle in order to feed hot metal directly to the regions of the mould situated on the sides of the nozzle and/or below it. Thus the aim in particular is to improve the thermal homogeneity of the metal present in the ingot mould.

One of the principal difficulties encountered in the use of these nozzles is that, in general, the liquid metal does not completely fill their internal space and the flow of metal there frequently takes place in an irregular and turbulent manner. This is the case in particular when the orifice of the tundish is not fully open. This leads to a high instability of the streams of metal leaving the outlets, and the flows inside the ingot mould become different from their optimum configuration which the nozzle is theoretically supposed to impose. The appearance of irregularities is then observed in the solidification of the product, which can seriously affect its final quality, above all in the case where thin strips are being cast.

This problem is remedied by inserting into the internal space of the nozzle obstacles which impose losses of pressure on the metal, impeding its natural flow. For the same flow rate of liquid metal, the speed of the flow is limited and thus the filling of the internal space in the nozzle is improved. In this way, the erratic variations in the flow of metal outside the nozzle are lessened. In the case of the nozzles in two parts referred to above, these obstacles may be inserted into the cylindrical first part or into its extension (see document EP-A-0 765 702). They may also comprise a “bar”, that is to say an elongate parallelepipedal element made of porous or perforated refractory disposed in the interior of the hollow element which constitutes the second part of the nozzle (see document EP-A-0 950 451). This bar also permits a more homogeneous feed to the metal outlet orifices which may be provided in the base or the lateral walls of the nozzle.

In this latter type of nozzle, the bar is disposed substantially in the central part of the height of the hollow element and rests on shoulders provided in the hollow element. It divides each of the outlets into two zones:

an upper zone through which liquid metal can flow without first having to pass through the bar;

a lower zone through which metal which has passed through the bar does not flow.

Experience shows that this arrangement has numerous drawbacks. In the first place the presence of the bar necessitates the production of outlets of relatively large diameter in order to allow the bar to be put in place, which is not always desirable from the hydrodynamic point of view. In fact, this large diameter itself necessitates a deep immersion of the second part of the nozzle in the casting space, since it is necessary to maintain a minimum distance between the top of the outlet and the surface of the liquid metal present between the rolls. If this minimum distance is not adhered to there is a danger of excessive agitation of the said surface, which makes the initiation of the solidification of the strip irregular. Furthermore, it may happen that, under the effect of the recirculation loops of the liquid metal between the rolls, liquid metal flows back into the upper zone of the outlets, which disrupts the good operation of the nozzle. Finally, deep immersion of the nozzle means that a substantial mass of refractory is in contact with the liquid metal present between the rolls, which is unfavourable from the thermal point of view, particularly at the start of casting when the nozzle is not yet in thermal equilibrium with the metal.

The object of the invention is to propose a nozzle equipped with a bar which does not have the aforementioned drawbacks.

To this end, the invention relates to a nozzle for the introduction of a liquid metal into an ingot mould for continuous casting of metals, of the type comprising a first tubular part of which one end is intended to be connected to a vessel containing the said liquid metal and of which the other opens into a second hollow part of elongate shape of which at least a portion of the internal space is oriented substantially perpendicular to the said first tubular part, the said hollow part having an outlet at each of its ends, a bar provided with perforations being disposed in the internal space in the said hollow part, characterised in that the outlets of the said hollow part are closed above the said bar.

The outlets of the said hollow part may be closed by projections provided on the upper face of the bar.

The said projections may have their wall turned towards the interior of the nozzle inclined.

The said bar may have a raised portion on at least a portion of the width of its upper face, the top of the said raised portion being situated on the longitudinal axis of the bar.

The said bar may have on its upper face transverse reliefs between which the perforations are provided.

The said transverse reliefs may have cross-sections of generally triangular shape.

The transverse relief situated at the centre of the bar may have a cross-section in the general shape of an isosceles triangle, and the other transverse reliefs may have cross-sections in the general shape of any kind of triangles.

The second hollow part of the nozzle may have one or more orifices provided in its base and/or its lateral walls.

As will be understood, the invention consists of providing a complete closure of the upper zone of the outlets of the second part of the nozzle above the bar.

The invention will be better understood upon reading the following description which is given with reference to the accompanying drawings, in which:

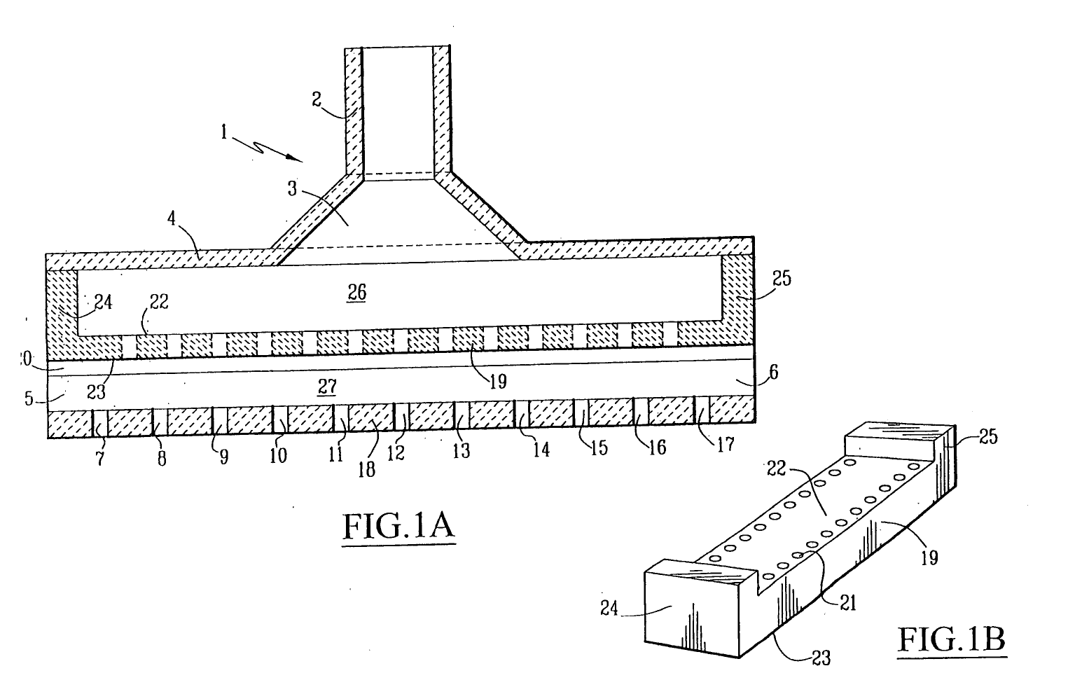

FIG. 1 a shows, viewed from the front and in longitudinal section, an embodiment of the nozzle according to the invention equipped with a bar which is shown in perspective view in FIG. 1b;

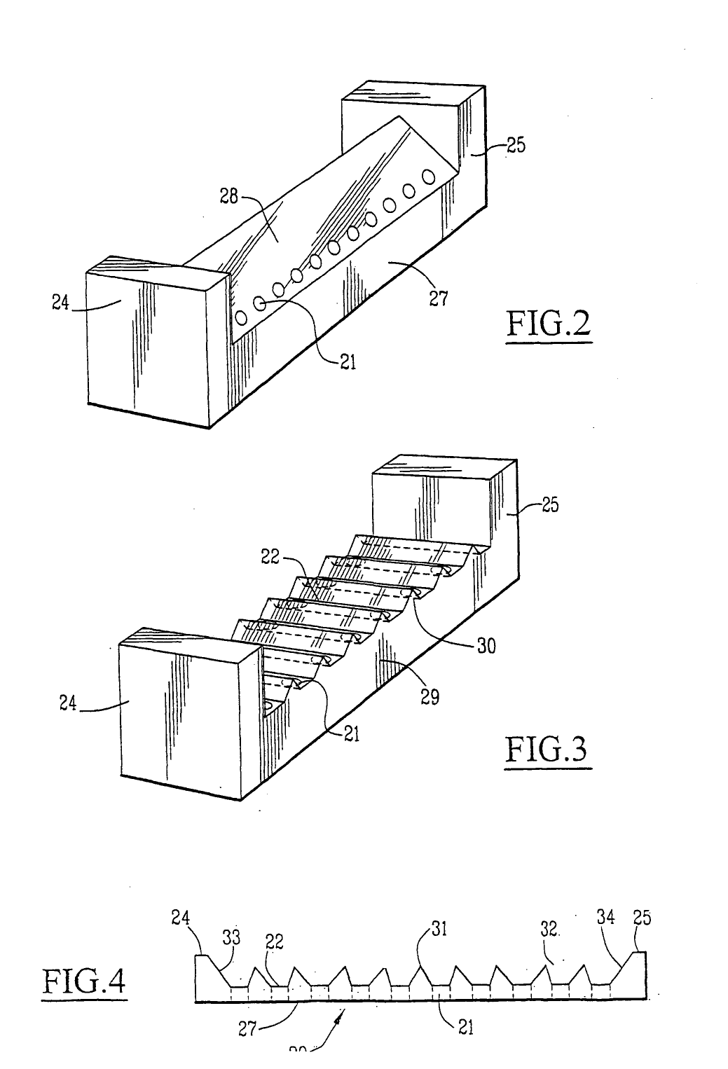

FIG. 2 shows, in perspective, another embodiment of the bar with which the nozzle according to the invention may be equipped;

FIG. 3 shows, in perspective, another embodiment of such a bar;

FIG. 4 shows, viewed in profile, a variant of the bar according to FIG. 3.

The nozzle 1 according to the invention which is shown in FIG. 1a is, by virtue of its narrow and elongate shape, particularly adapted for use on a plant for casting thin strips between two rolls which are cooled internally and set in rotation, according to a method which is well known at present. As in the prior art described previously, it comprises a first part composed of a cylindrical tube 2 of which the upper end (not shown) is intended to be connected to the outlet orifice of a tundish. This cylindrical tube 2 opens into the internal space 3 in the second part of the nozzle 1, which is composed of a hollow element 4 of elongate shape and is sufficiently narrow to permit its insertion into the casting space of the plant. In accordance with the prior art, this hollow element 4 has various orifices through which the liquid metal can leave the nozzle 1, namely:

two outlets 5, 6, which in the non-limiting example shown here are of rectangular cross-section, each provided at one end o the hollow element 4 and intended to be oriented towards the short sides of the casting space, and through which most of the liquid metal passing through the nozzle 1 flows; in the example according to FIG. 1a, these outlets 5, 6 are oriented horizontally, but they could equally be oriented obliquely; they may also have a cross-section of different shape (for example circular, oval or more complex), in a conventional manner;

a series of cylindrical outlet orifices 7-17 of small diameter which are oriented vertically, provided in the median plane of the base 18 of the hollow element 4 and intended to feed hot metal directly to the zones in the casting space which are situated below the nozzle; as a variant it is possible, as known in document EP-A-0 771 600, to provide not one but two series of such orifices, each disposed on either side of the median plane of the base 18 of the hollow element 4.

Another variant would consist of adding to the outlet orifices 7-17 (or substituting them by) orifices provided in the long lateral walls of the hollow element 4 and oriented in the direction of the long sides of the casting space (in other words, in the direction of the rolls in the case of a twin-roll casting plant). These orifices 7-17 may also not be strictly cylindrical but may have a cross-section which is for example elliptical. They may also (particularly in one of the variants of EP-A-0 771 600) be oriented obliquely. Finally, they may be replaced by a plurality of slots each extending over a part or all of the length of the base 18 of the hollow element 4, in which case it would be important for them to be fed in a homogeneous manner over all of their length. It must also be understood that it would still be within the scope of the invention not to provide any outlet orifice for the liquid metal other than the outlets 5, 6.

The nozzle 1 also has, disposed in its internal space 3, a perforated bar 19 resting on shoulders 20 provided on the walls of the hollow element 4 and extending over the entire length of this hollow element 4. Its function is, as is known, to create losses of pressure in the liquid metal in such a way as to obtain better filling of the internal space and thus to regularise the flows of liquid metal outside the nozzle 1. This bar has a generally parallelepipedal shape in the example shown in FIGS. 1a and 1b. It has perforations 21 which pass through it from one side to the other, from its upper face 22 to its lower face 23. In the illustrated example, these perforations 21 are disposed in a double row and distributed on either side of the longitudinal axis of the bar 19, and they have a strictly cylindrical shape.

It must be understood that this arrangement and this shape are merely non-limiting examples. In particular it is possible to provide only one single row of perforations 21.

According to the invention the parts of the outlets 5, 6 situated above the bar 19 are closed off in such a way as to force all of the liquid metal passing through the nozzle 1 to pass through the bar 19. In the example shown in FIGS. 1a and 1b, this closure is achieved by virtue of projections 24, 25 produced integrally during construction with the ends of the bar 19. However, it would still be in accordance with the invention to achieve this closure with the aid of attached parts fixed on the bar 19 before or after it is put in place in the nozzle 1 or with the aid of a workable refractory applied after the bar 19 has been put in place.

In this way the internal space in the hollow element 4 is divided into two communicating parts separated by the bar 19: an upper part 26 and a lower part 27 which, alone, opens to the exterior of the nozzle 1 via the lower unclosed parts of the outlets 5, 6 and the orifices 7-17.

The invention also has the following advantages over the known nozzles which are equipped with a bar and of which the upper parts of the outlets are not closed.

The flow of the liquid steel inside the nozzle 1 is better throttled and is channelled more strictly, which gives it a better stability over time. Thus the variations of the flow rate of liquid metal leaving the tundish have fewer repercussions on the hydrodynamics of the liquid steel, not only in the nozzle 1 but also in the casting space of the continuous casting machine. In particular, the equality of distribution of the flow of metal between the two outlets 5, 6 is better ensured.

The recirculation of liquid metal in the interior of the outlets 5, 6, coming from the casting space, is avoided, which also contributes to a good regularity of the flows not only in the nozzle 1 but also in the casting space.

It is possible to immerse the nozzle I less deeply in the casting space, since this immersion is calculated no more from the top of the internal space of the hollow element 4 but from the lower face 23 of the bar 19. Therefore a smaller quantity of refractory is immersed in the liquid steel, which is favourable from the thermal point of view. If it is chosen to maintain an immersion similar to that of the nozzle according to the prior art with outlets which are not partially closed, this results in metal arriving at a greater average depth, which reduces the agitation of the surface of the liquid metal present in the casting space. Therefore the start of the solidification takes place more regularly.

Good sealing of the bar 19 is better ensured due to the increase in the surface thereof which is in contact with the hollow element 4 due to the projections 24, 25 or generally due to the material which ensures the closure of the upper part of the outlets 5, 6.

As a variant, the bar 19 may be given various shapes, of which non-limiting examples are given in FIGS. 2 to 4.

As is known from document EP-A-0 950 451, the bar 27 may have provided on it a raised portion which extends longitudinally over the length of the bar 19 and over at least a part of the width thereof. In the example shown in FIG. 2, this raised portion 28 extends over the entire length and the entire width of the bar 27 and has a uniform triangular cross-section, the apex of the triangle coinciding with the longitudinal axis of the bar 27. The function of this raised portion 28 is to cause the jet of metal coming from the cylindrical tube 2 of the nozzle 1 to “burst”, distributing it in a symmetrical manner over the cross-section of the hollow element 4 of the nozzle 1. By comparison with a purely parallelepipedal bar, a more homogeneous filling is obtained which is more constant over time. The closure of the upper part of the outlets 5, 6 according to the invention enables the advantages obtained by the type of bar 27 to be further accentuated. The other examples of bars with a central raised portion which are described in EP-A-0 950 451 can also be adapted to the invention, and reference may be made to that document for a more detailed description of these examples.

A variant of the configuration of the bar is shown in FIG. 3. Here the bar 29 is of generally parallelepipedal shape and has on its upper surface 22 transverse reliefs 30 of triangular cross-section between which the perforations 21 are pierced. These transverse reliefs 30 constitute obstacles to the flows of liquid metal, making it possible to obtain a better homogeneity of the distribution of the liquid metal between the various perforations 21. The closure of the upper parts of the outlets of the nozzle 1 make it possible to take optimum advantage of the existence of these transverse reliefs 30. In fact, the good filling of the upper part 26 of the hollow element 4 which it provides helps to stabilise the flows over time, and therefore to ensure that the effect of the transverse reliefs 30 is obtained in a reliable and constant manner. If the outlets of the nozzle 1 were left free in their upper part, the flows in the interior of the nozzle 1 would be much more uncertain, and the effect of the transverse reliefs 30 would not be controlled.

As a variant, it may be proposed to give the transverse reliefs 30 cross-sections of different shapes over the length of the bar 27, as shown in FIG. 4.

In this configuration the central transverse relief 31 has a cross-section in the shape of an isosceles triangle, in such a way as to distribute the liquid metal equally between the right-hand side and the left-hand side of the nozzle 1, whilst the other transverse reliefs 32 have triangular cross-sections in the shape of any kind of triangles, calculated in order to homogenise the distribution of the liquid metal between the different perforations 21. In this example of the configuration, the walls of the projections 24, 25 which close off the upper parts of the outlets of the nozzle 1 have also been given inclined faces 33, 34 which are turned towards the interior of the nozzle 1 and are not vertical. This arrangement seeks to avoid the formation of dead zones in the liquid metal at the level of the intersection between the projections 24, 25 and the upper face 22 of the bar 29. Naturally, this characteristic can also be transferred to the other configurations of bars which have been described.

In the variants which have just been described and illustrated, the angles of the transverse reliefs (30, 31, 32) are sharp angles, but it would still be within the scope of the invention to round them in such a way as to avoid possible uncontrolled erosion thereof under the effect of friction with the liquid metal.

1. Nozzle (1) for the introduction of a liquid metal into an ingot mould for continuous casting of metals, of the type comprising a first tubular part (2) of which one end is intended to be connected to a vessel containing the said liquid metal and of which the other end opens into a second hollow part (4) of elongate shape of which at least a portion of the internal space (3) is oriented substantially perpendicular to the said first tubular part (2), the said hollow part (4) having an outlet (5, 6) at each of its ends, a bar (19, 27, 29) provided with perforations (21) being disposed in the internal space (3) in the said hollow part (4), characterised in that the outlets (5, 6) of the said hollow part (4) are closed above the said bar (19, 27, 29).

2. Nozzle as claimed in claim 1, characterised in that the outlets (5, 6) of the said hollow part (4) are closed by projections (24, 25) provided on the upper face of the bar 19, 27, 29).

3. Nozzle as claimed in claim 2, characterised in that the said projections (24, 25) have their wall (33, 34) turned towards the interior of the nozzle (1) inclined.

4. Nozzle as claimed in one of claims 1 to 3, characterised in that the said bar (27) has a raised portion (28) on at least a portion of the width of its upper face (22), the top of the said raised portion (28) being situated on the longitudinal axis of the bar (27).

5. Nozzle as claimed in one of claims 1 to 3, characterised in that the said bar (29) has on its upper face (22) transverse reliefs (30, 31, 32) between which the perforations (21) are provided.

6. Nozzle as claimed in claim 5, characterised in that the said transverse reliefs (30, 31, 32) have cross-sections of generally triangular shape.

7. Nozzle as claimed in claim 6, characterised in that the transverse relief (31) situated at the centre of the bar (29) has a cross-section in the general shape of an isosceles triangle, and in that the other transverse reliefs (32) have cross-sections in the general shape of any kind of triangles.

8. Nozzle as claimed in one of claims 1 to 7, characterised in that the second hollow part (4) has one or more orifices (7-17) provided in its base (18) and/or its lateral walls.
